(19) United States
(12) Patent Application Publication
(10) Pub. No.: US 2010/0294429 A1
(43) Pub. Date: Nov. 25, 2010

(54) EPOXY RESIN FORMULATIONS

(75) Inventor: Bernd Hoevel, Sinzheim (DE)

Correspondence Address: The Dow Chemical Company, P.O. BOX 1967, Midland, MI, 48641, US

(73) Assignee: Dow Global Technologies Inc., Midland, MI (US)

(21) Appl. No.: 12/679,445

(22) PCT Filed: Sep. 24, 2008
(86) PCT No.: PCT/US08/77521

§ 371 Date: May 26, 2010

Related U.S. Application Data
(60) Provisional application No. 60/995,778, filed on Sep. 28, 2007.

(51) Int. Cl. H01B 13/22; C08K 5/41

(52) U.S. Cl. 156/330; 524/172

(57) ABSTRACT

A curable halogen-free epoxy resin composition comprising from 40 to 80 percent by weight of a phenol aldehyde condensation product, from 10 to 40 percent by weight of a phosphorous-containing phenolic epoxy resin, and from 10 to 40 percent by weight of an aromatic hardening agent having a sulphone group and an amine group. A prepreg and laminate can be formed from this composition.

### BACKGROUND TO THE INVENTION

The present invention relates to epoxy resin formulations and in particular to halogen-free curable epoxy resin formulations and to cured epoxy resin formulations with a maximum operating temperature of greater than 200° C.

Metal laminates are increasingly being utilised as a replacement for organic substrate materials in order to dissipate heat. Thermal management is important in the automotive industry and also in high speed computer applications. There is therefore an increasing need for laminates capable of operating at high temperatures, for example the temperatures found in the engine compartment of automobiles. The use of lead-free solders also results in the need for electrical laminates capable of operating at higher temperatures. As a general rule, it is required that laminates need to have a glass transition temperature which is in excess of the maximum operating temperature to which the laminate will be subjected.

Recent advances in automotive electronic materials such LED rear and head lamp lighting systems require that the resins employed have a maximum operating temperature of at least 200° C. (typically referred to as “Maximum Operating Rating 200” or “MOT 200”). Another application in which a laminate having a high maximum operating temperature is required is when used as chip “under fill” in flip chip applications.

It is difficult to achieve this specification using standard brominated epoxy resin formulations as the brominated species are prone to decomposition at these temperatures.

In order to obtain a high MOT rating, it has hitherto been necessary to utilise relatively expensive materials for example compositions containing bismaleimide-triazine (BT) resins to provide the glass transition temperature, and bromine-containing components to meet flame retardancy requirements.

Since BT-Epoxy resins are significantly more expensive than other epoxy resins, alternative epoxy resin formulations which are non-halogenated but which fulfil the MOT 200 rating would be desirable. MOT is measured according to Underwriters Laboratories standard UL 746 E. It is typically measured using the 10 and 56 day tests. To obtain an “assigned temperature rating” for a resin, the test sample must pass a bond strength test at a force of one pound per inch of width after oven conditioning for 10 and 56 days, with the temperature of the oven being related to the MOT rating. The formulas for calculating the actual 10 and 56 day oven temperature are as follows:

10 day oven Temperature=1.076*(“desired Rating”+288)−273

56 day oven Temp.=1.02*(“desired Rating”+288)−273

A curable resin having superior physical properties such as a glass transition temperature of greater than 200° C., produced using commercially available and cost-effective components would be highly desirable.

WO2005/118604 discloses phosphorus-containing compounds useful for making halogen-free, ignition resistant polymers.

WO2005/11860 discloses phosphorous containing epoxy compounds which can be used in combination with other epoxy compounds.

U.S. Pat. No. 4,338,225 relates to resins formed from the reaction product of an epoxy resin and a hardener, such as a diamine hardener for example diaminodiphenylsulphone.

Surprisingly, we have now found that the combination of certain specific epoxy resin, together with specific phosphorous-containing epoxy resins and specific hardening agents can provide compositions which, on curing, have a glass transition temperature of greater than 200° C.

### SUMMARY OF THE INVENTION

In a first aspect of the present invention, there is provided a halogen-free curable epoxy resin composition comprising:

from 40 to 80 percent by weight of a phenol-aldehyde condensation product, preferably a novolac epoxy resin;

from 10 to 40 percent by weight of a phosphorous-containing phenolic resin; and

from 10 to 40 percent by weight of a hardening agent which is an aromatic hardening agent containing a sulphone group and an amine group.

Compositions according to the present invention have a glass transition temperature Tg, when cured, of greater than 200° C. Preferably, the compositions have a Tg of greater than 210° C., more preferably greater than 220° C. and most preferably greater than 230° C.

Other components may be included in the curable epoxy resin composition. For example, a catalyst capable of promoting the reaction between the epoxy resins and the hardener may be included in the composition. Where such a catalyst is present, it is preferably present in amounts of from 0.5 to 2% based on the total weight of the composition.

In addition, other components including other multifunctional epoxy or phenolic components, amine hardeners and fillers can also be present.

It is preferred that the composition consists essentially of, more preferably consists of, the phenol-aldehyde condensation product, the phosphorous-containing phenolic resin, at least one hardening agent comprising an aromatic hardening agent containing a sulphone group and an amine group, at least one catalyst and at least one solvent.

The curable epoxy resin composition can be used in a number of different applications, in particular where high temperature laminates are required, such as in electrical laminate applications and used for printed circuit boards. The composition is particularly suitable for use in automotive electrical laminates.

In automotive uses, the typical high temperature exposure occurring in the engine compartment is a temperature of greater than 150° C. In the engine transmission system, temperatures can reach up to 200° C. Laminates with higher MOT temperatures will enable the electrical circuits to be brought closer to the exhaust system (which can operate at temperatures greater than 800° C. and to the brake system (which can operate at temperatures greater than 300° C.).

Automotive lighting systems also benefit from laminates with higher MOT temperatures. The thermal management of LEDs plays an important role in this application. About 90% of the electrical energy in a red InGaAs LED is converted into visible light. Not all of this light energy leaves the semiconductor chip, with the remaining energy being converted to heat. If the semiconductor chip exceeds the glass transition temperature of the epoxy material surrounding it, the epoxy material begins to soften.

The thermal management of chip packaging is also important. With the ever increasing power of semiconductors, the heat that these semiconductor chips are generating is increasing. Currently this heat absorbed by active cooling systems, such as heat pipe systems. Material solutions to dissipate the heat would provide a much cheaper solution to the problem. For this high MOT rating materials are required.

A typical example of a process for making such a laminate may comprise the following steps:

(1) An epoxy-containing formulation is applied to or impregnated into a substrate by rolling, dipping, spraying, other known techniques and/or combinations thereof. The substrate is typically a woven or nonwoven fiber mat containing, for instance, glass fibers or paper. The epoxy resin formulation employed for impregnating is generally referred to as “varnish”.

(2) The impregnated substrate is “B-staged” by heating at a temperature sufficient to draw off solvent in the epoxy-containing formulation and optionally to partially cure the epoxy-containing formulation, so that the impregnated substrate can be handled easily. The “B-staging” step is usually carried out at a temperature of from 90° C. to 210° C. and for a time of from 1 minute to 15 minutes. The impregnated substrate that results from B-staging is generally referred to as a “prepreg”. The temperature used for “B-staging” is most commonly 100° C. for composites and 130° C. to 200° C. for electrical laminates.

(3) One or more sheets of prepreg are stacked or laid up in alternating layers with one or more sheets of a conductive material, such as copper foil, if an electrical laminate is desired.

(4) The laid-up sheets are pressed at high temperature and pressure for a time sufficient to cure the resin and form a laminate. The temperature of this lamination step is usually between 100° C. and 230° C., and is most often between 165° C. and 200° C. The temperature of the lamination step preferably is adjusted to the final Tg of the laminate so that the pressing temperature is at least 5-10° C. above the expected Tg. The lamination step may also be carried out in two or more stages, such as a first stage between 100° C. and 150° C. and a second stage at between 165° C. and 190° C. The pressure is usually between 50 N/cm² and 500 N/cm². The lamination step is usually carried out for a time of from 1 minute to 200 minutes, and most often for 45 minutes to 90 minutes. The lamination step may optionally be carried out at higher temperatures for shorter times (such as in continuous lamination processes) or for longer times at lower temperatures (such as in low energy press processes).

Optionally, the resulting laminate, for example, a copper-clad laminate, may be post-treated by heating for a time at high temperature and ambient pressure. The temperature of post-treatment is usually between 120° C. and 250° C. The post-treatment time usually is between 30 minutes and 12 hours.

In a second aspect of the present invention, there is provided a method of making a prepreg comprising the step of impregnating a reinforcing web with the composition of the first aspect.

In a third aspect of the present invention, there is provided a method of making an electrical laminate comprising the steps of:

heating the above prepreg to a temperature sufficient to partially react the epoxy component of the composition;

laminating one or more layers of the prepreg with an electrically conductive material; and

heating the so formed laminate at elevated pressure and elevated temperature to form an electrical laminate.

In a fourth aspect of the present invention, there is provided a curable epoxy resin composition comprising:

from 40 to 80 percent by weight of a phenol-aldehyde condensation product, preferably a novolac epoxy resin;

from 10 to 40 percent by weight of a phosphorous-containing phenolic resin; and

from 10 to 40 percent by weight of a hardening agent which is either an aromatic hardening agent containing a sulphone group and an amine group, wherein the resin is substantially free of halogen. A resin which is “substantially free of halogen” means that the resin is in compliance with applicable industry norms as there are:
JPCA (Japan Printed Circuit Association) JPCA-ES-01-1999 defines criteria and method for “halogen-free”
   Br<0.09 wt % (900 ppm)
   Cl<0.09 wt % (900 ppm)
IEC (International Electrotechnical Commission)
   Finalized requirements of IEC 61249-2-21:
      900 ppm maximum Cl
      900 ppm maximum Br
      1500 ppm maximum total halogens
IPC-4101B has adopted the IEC definition of halogen-free
   900 ppm maximum Cl
   900 ppm maximum Br
   1500 ppm maximum total halogens
Note: fluorine, iodine, and astatine (other Group VIIA halogens) are not restricted in the industry definition of “halogen-free”.

### DETAILED DESCRIPTION OF THE INVENTION

The phenol-aldehyde condensation product is preferably present in an amount of from 50 to 70 weight percent based on the total weight of the curable composition, more preferably from 55 to 65 weight percent.

The phenol-aldehyde condensation product can be an epoxy novolac resin or other multi-functional epoxy resin such as a tris-phenol-glycidylether or tetraphenol-glycidylether. Preferred are epoxy novolac resins, which can be any epoxy novolac resin (sometimes referred to as an epoxidized novolac resin, a term which is intended to embrace epoxy phenol novolac resins and epoxy cresol novolac resins, epoxy bisphenol A novolac resins or dicyclopentadiene phenol novolac resins as well as other epoxy novolac resins). Such epoxy novolac resin compounds have the general chemical structural formula illustrated by Formula (a) as follows:

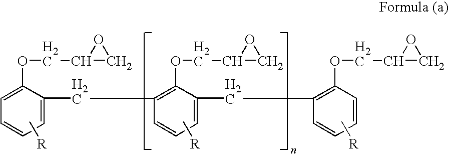

wherein “R” is hydrogen, a C₁-C₃ alkyl, e.g., methyl or an aromatic group such as isopropylidene-hydroxyphenyl groups; and n is 0 or an integer from 1 to 10. n preferably has an average value of from 0 to 5. The preferred epoxy novolac resin is when R is a hydrogen atom in the above Formula (a).

Epoxy novolac resins (including epoxy cresol novolac resins) are readily commercially available, for example under the trade names D.E.N. (trademark of The Dow Chemical Company), and QUATREX and TACTIX 742 (trademarks of Ciba Geigy). The materials of commerce generally comprise mixtures of various species of the above Formula and a convenient way of characterizing such mixtures is by reference to the average, n′, of the values of n for the various species. Preferred epoxy novolac resins for use in accordance with the present invention are those in which n has a value of from about 0 to about 10, more preferably from about 1 to about 5.

The phosphorous-containing epoxy compound is a phosphorous-containing phenolic epoxy resin, and is preferably utilised in the curable composition in an amount of from 10 to 30 weight percent, more preferably from 15 to 20 weight percent based on the total weight of the composition. Preferably, the phosphorous-containing phenolic epoxy compound is formed from the reaction of a phenolic epoxy resin with

a phosphorous containing compound, which is the reaction product of:
at least one organophosphorus compound having a group selected from the group H—P═(O); the group P—H and the group P—OH; and
at least one compound having the following Formula (I):

[R′(Y)_{m′}]ₘ(X—O—R″)ₙ Formula (I)
wherein
R′ is an alkyl or aryl group having from 1 to 24 carbon atoms;
Y is selected from hydroxy, carboxylic acid, carboxylate, acid anhydride, amine, —SH, —SO₃H, —CONH₂, —NHCOOR, phosphate and phosphinate groups;
X is a hydrocarbylene group;
R″ is hydrogen or a hydrocarbyl group having from 1 to 8 carbon atoms; R is an alkyl or aryl group having from 1 to 12 carbon atoms; and

m′, m and n are, independently, equal to or greater than 1.

Preferably, the phosphorus-containing compound has at least two phenolic aromatic rings preferably linked by a hydrocarbylene group or hydrocarbylene ether group and a phosphorus content of at least 4 weight-percent.

The compound having one epoxy group per molecule is preferably a cross-linkable epoxy resin or a blend of two or more epoxy resins having more than one epoxy group per molecule.

Suitable epoxy-containing molecules include epichlorhydrin, glycidylether of polyphenols (such as bisphenol A, bisphenol F, phenol novolac, cresol phenol novalac), glycidylether of methacrylate, glycidylether of acrylate and other similar compounds.

In Formula (I), each —(—X—O—R″) group may be bonded to the same or different atom in “R′”. Preferably, each —(—X—O—R″) group is bonded to a different atom in “R′”.

X preferably has from 1 to 8, and more preferably from 1 to 4, carbon atoms. In a preferred embodiment, X is an alkylene group having from 1 to 8, preferably from 1 to 4, and even more preferably 1 or 2, carbon atoms, such as methylene, ethylene, propylene, isopropylene, butylene, isobutylene, and the like. Methylene is the most preferred X group.

R″ has 1, preferably at least 2, and more preferably at least 3, carbon atoms; and preferably up to 8, more preferably up to 6, and even more preferably up to 5, carbon atoms. The hydrocarbyl is preferably an alkylene group, such as methyl, ethyl, propyl, isopropyl, butyl, isobutyl, pentyl, hexyl, heptyl, and octyl. Most preferred for the R″ group are butyl and isobutyl.

R′ preferably comprises at least one arylene group and optionally at least one hydrocarbylene group or hydrocarbylene ether group. The R′ group more preferably comprises at least two aromatic groups linked to each other by a hydrocarbylene group or hydrocarbylene ether group. The aromatic groups are preferably phenyl groups and the hydrocarbylene group is preferably X as defined above, most preferably a methylene group and the hydrocarbylene ether is preferably a methylene oxy group.

Y is a functional group capable of reacting with an epoxy group, an ethoxy group or a propoxy group. The Y functional groups are preferably selected from hydroxyl (—OH), carboxylic acid (—C(O)OH), carboxylate (—C(O)OR′″), carboxylic acid anhydride, and a primary or secondary amine (—NH₂, —NHR″″ or ═NH, wherein “═” refers to two covalent bonds to the same or different atoms of R′).

R′″ may be an alkali metal, such as Na⁺ or K⁺, or a hydrocarbyl group having up to 8, preferably up to 4, more preferably up to 2, carbon atoms, such as methyl, ethyl, propyl, isopropyl, butyl, isobutyl, and the like

R″″ is a hydrocarbyl group, such as an aryl group, an alkyl group, or an alkaryl group, which preferably has up to 20, more preferably up to 12, and even more preferably up to 4, carbon atoms.

The carboxylic acid anhydride is preferably selected from substituted or unsubstituted succinic anhydride, maleic anhydride and phthalic anhydride. Each substituent, when present is one or more hydrogen atoms or hydrocarbyl group, such as an alkyl group preferably having up to 12, and more preferably, up to 4, carbon atoms.

The hydroxyl, carboxylic acid and carboxylic acid anhydride functionalities are preferred, and the hydroxyl functionality is most preferred for the R″″ group.

The preferred compounds of Formula (I) are those compounds that meet the Formula (I):

[R′(Y)_{m′}]ₘ(X—O—R″)ₙ

and at least one (X—O—R″) group is in the middle of the backbone of the chemical structure. For example, preferred compounds include those that contain at least two (X—O—R″) groups on at least one of the same R′(y)_{m′} groups. In addition, the compounds that are useful include, for example those that use meet the following criteria:
(a) n is preferably greater than m; or
(b) when n is equal to 1, then m must be greater than 3 and at least one (X—O—R″) group is in the middle of the backbone of the chemical structure; or
(c) when m is equal to 1, then n must be greater than 1; or
(d) when n is equal to 2, then at least one of the (X—O—R″) groups must be in the middle of the backbone of the chemical structure.

In Formula I, m′ is preferably less than 10, m is preferably less than 100, and n is preferably less than 200.

Preferred compounds of Formula I may be represented by the following Formula (II):

[Ar(Y)_{m′}—X′]ₐ[Ar(Y)_{m′}—X]_{b}(X—O—R″)ₙ Formula (II)

wherein each Ar independently is an aromatic group, preferably a phenyl group, optionally substituted with one or more groups, preferably selected from alkyl, alkoxy, and alkanol, having 1 to 4 carbon atoms (e.g., methyl, methoxy, methanol, ethyl, ethoxy, ethanol, propyl, propoxy, propanol, isopropyl, isopropanol, butyl, butoxy, butanol) such as, for example, a tolylene and/or xylylene group; at least one of the (X—O—R″) groups is on at least one of the Ar groups; n, m′, X, Y, and R″ have the same meaning as in Formula (I); X′ each independently may be X, X—O—X, or X—O—X—O—X; “a” and “b” each independently represent a number equal to or greater than zero, but both cannot be zero.

In Formula (II), “a” is preferably up to 100, “b” is preferably up to 100 and “n” is preferably up to 200.

A more preferred compound of Formula I may be represented by the following Formula (III):

(R″—O—X)_{c}[Ar(Y)_{m′}—X—O—X]ₐ[Ar(Y)_{m′}—X]_{b}[Ar(Y)_{m′}]_{b′}(X—O—R″)_{d} Formula (III)

wherein Ar, m′, a, b, X, Y, and R″ have the same meaning as in Formula (II); subscripts b′, c, and d each independently represent a number equal to or greater than zero. In Formula (III), c is preferably up to 200 and d is preferably up to 200.

The “Y” groups are preferably bonded directly to an Ar group. Examples of preferred “Ar(Y)” include phenol, cresol, and xylenol, and the corresponding divalent counterparts thereof.

The units with the subscripts a, b′, and b may be present in any order in a random or block configuration. Each of the subscripts a, b, b′, c and d independently are preferably at least 1. Each of the subscripts a, b, b′, c and d independently are more preferably at least 5; yet more preferably at least 10 and preferably not greater than 1000, and more preferably not greater than 100. In one embodiment, the subscripts a, b, b′, c and d independently are preferably not greater than 50, more preferably not greater than 30 and even more preferably not greater than 10.

Preferred compounds of Formula (I) may further be represented by the following Formula (IV):

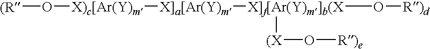

wherein e is an integer from 0 to 4; f is 1 or greater and preferably less than 50; and m′, R″, Ar, Y, X, a, b, c and d are as defined above with reference to Formula (III).

Preferred compounds of Formula (III) may be represented by the following formulas, Formula (V) and Formula (VI);

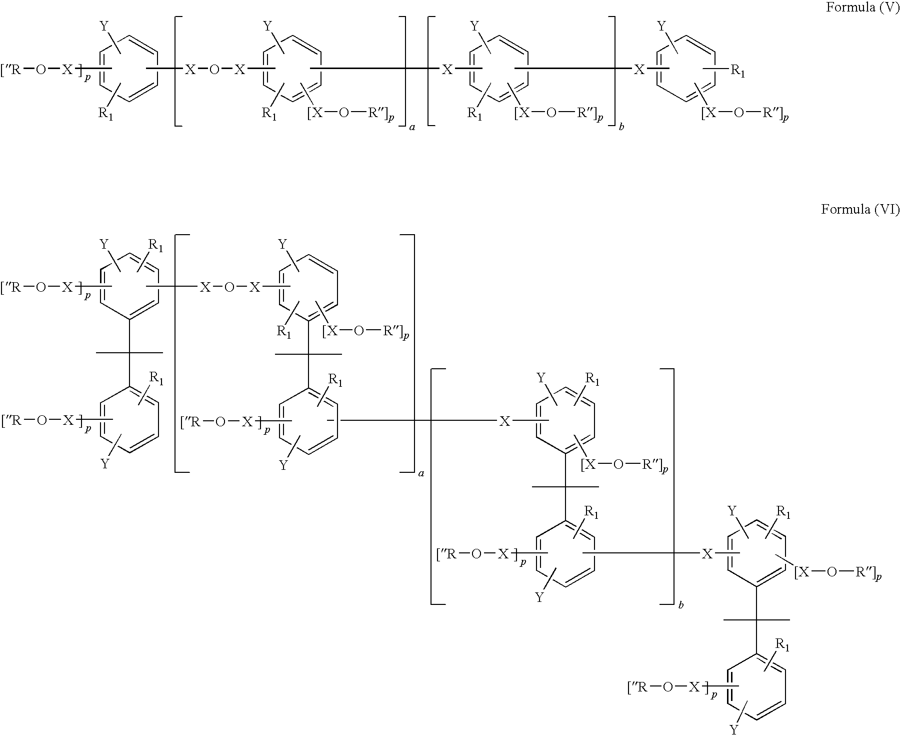

wherein “R1” each independently is hydrogen or an alkyl group having from 1 to 10 carbon atoms,

“p” each independently represents a number from zero to 4;

“a” and “b” each independently represent a number equal to or greater than zero; and “X”,

“Y” and “R” have the same meaning as in Formula (III).

In a preferred embodiment, the compounds of Formula (III), that is Component (B), may be prepared by first reacting (a) phenols, cresols, xylenols, biphenol-A, and/or other alkyl phenols and (b) formaldehyde, to form one or more monomeric, dimeric or higher condensation products. Subsequently, the condensation products resulting from reacting (a) and (b) above are modified by etherification, either partially or fully etherified, with at least one monomeric alcohol. The monomeric alcohol is ROH wherein R is the same as defined above for Formula (I). Examples of the resultant etherified products which can be used as Component (B), are for example etherified resole resins such as those described in U.S. Pat. No. 4,157,324, and U.S. Pat. No. 5,157,080.

Component (B) made by the above reaction of (a) and (b) preferably contains low amounts of the starting raw materials such phenol, cresol, bisphenol A and formaldehyde as residual monomers in the reaction product (that is Component (B)) for example less than 3 wt percent, preferably less than 2 wt percent and more preferably less than 1 wt percent.

It is preferable to use etherified resoles over non-etherified resoles as Component (B) in the present invention because etherified resoles are more storage stable at room temperature (about 25 C) whereas non-etherified resoles have a tendency to undergo self condensation; and at elevated temperature, typically greater than 25 C, preferably greater 100 C and more preferably greater 150 C and even more preferably greater than 170 C, and generally less than 250 C and preferably less than 220 C resoles have tendency to undergo self condensation rather than to react with the phosphorous compounds of Component (A). Thus, it is advantageous to select etherified resoles as Component (B) that have a lower tendency to undergo self condensation and that tend to favor the main condensation reaction with Component (A) for example via the alkyl group R″.

An example of the preferred condensation product prepared by reacting (a) and (b) as described above is illustrated as according the following general chemical equation:

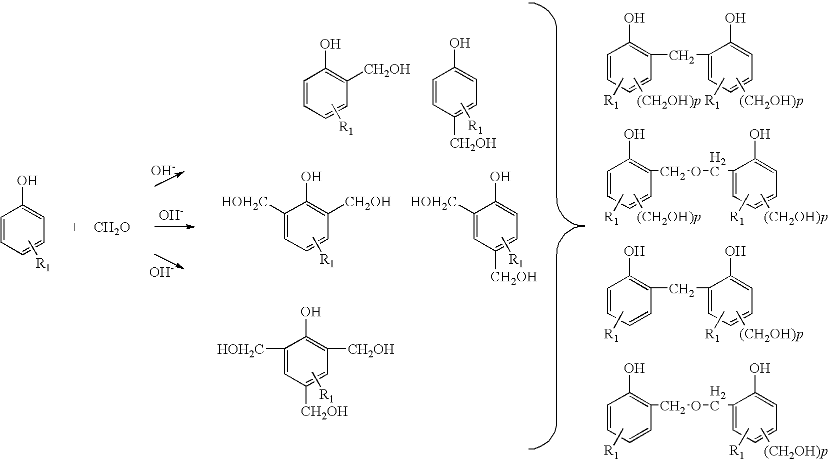

wherein “p” is an integer from 1 to 4 independently; and R₁ is hydrogen or an alkyl group having from 1 to 10 carbon atoms independently.

The above reaction provides a mixture of different isomer condensation products having methylene linkage or a dimethylene ether linkage such as (1) having two CH₂OH (one on each benzene ring); or (2) having one CH₂OH group on one benzene ring.

The CH₂OH groups in the above condensation products illustrated in the above general chemical equation are partially or fully etherified with an alcohol to provide Component (B) useful in the present invention. In this embodiment a mixture of different isomers of the condensation product can be formed.

The number average molecular weight of the compounds of Formulas (I) to (IV) is preferably at least 50, more preferably at least 200, and even more preferably at least 500; and is preferably not greater than 10,000, more preferably not greater than 8,000, and even more preferably not greater than 5000. The weight average molecular weight is preferably at least 100, more preferably at least 400, and even more preferably 1000; and is preferably not greater than 15,000, more preferably not greater than 3,000, and even more preferably not greater than 1,500.

Component (B) is preferably substantially free of bromine atoms, and more preferably substantially free of halogen atoms.

An example of Component (B) is shown in the following chemical Formula (VII):

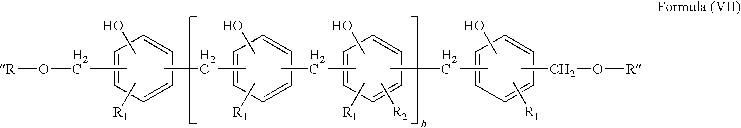

wherein “R2” each independently is hydrogen, an alkyl group having from 1 to 10 carbon atoms, CH₂OH, or CH₂OR″;

R1 each independently is hydrogen or an alkyl group having from 1 to 10 carbon atoms;

R″ is a hydrogen or a hydrocarbyl group having from 1 to 8 carbon atoms; and

b represents a number equal to or greater than zero.

Other examples of Component (B) are shown in the following chemical formulas, Formula (VIII) and Formula (VIIIa):

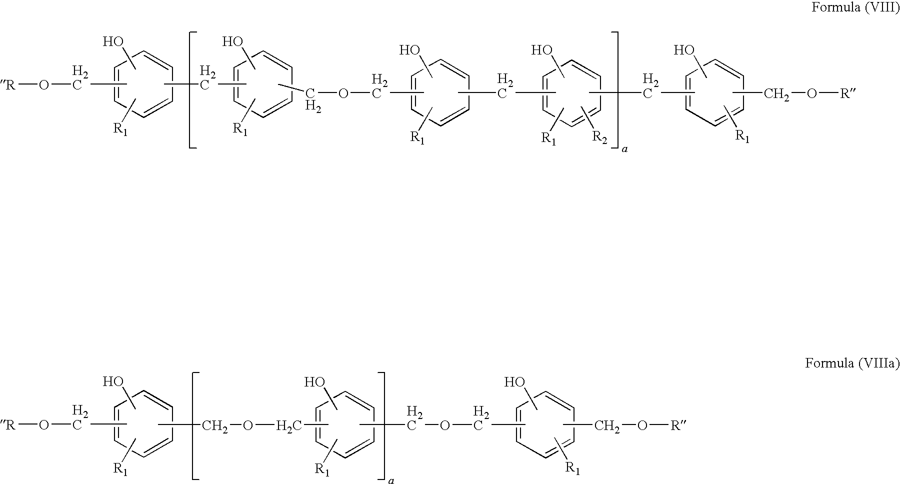

wherein “R2” each independently is hydrogen, an alkyl group having from 1 to 10 carbon atoms, CH₂OH, or CH₂OR″;

R1 each independently is hydrogen or an alkyl group having from 1 to 10 carbon atoms;

R″ is a hydrogen or a hydrocarbyl group having from 1 to 8 carbon atoms; and

a represents a number equal to or greater than zero.

Still other examples of Component (B) are shown in the following chemical formulas Formula (IX) and Formula (IXa):

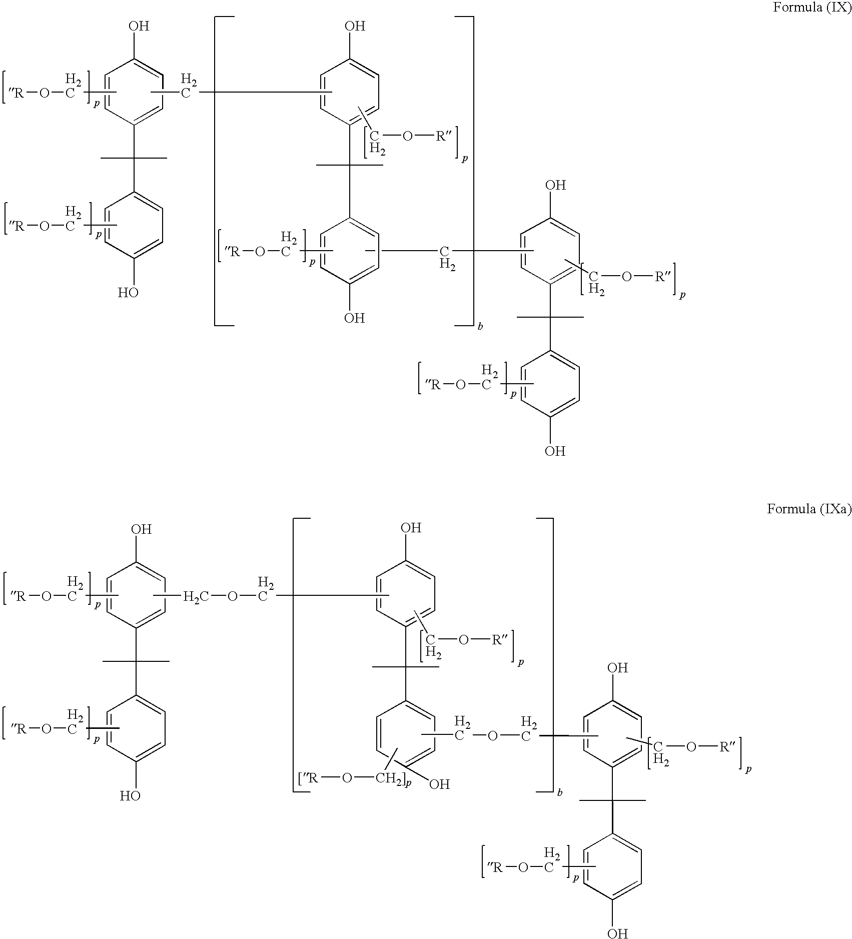

wherein R″ is a hydrogen or a hydrocarbyl group having from 1 to 8 carbon atoms;

b represents a number equal to or greater than zero; and

p represents a number equal to or greater than zero.

Examples of commercially available products suitable for use as Component (B) include SANTOLINK™ EP 560, which is a butyl etherified phenol formaldehyde condensation product and PHENODUR™ VPR 1785/50, which is a butoxymethylated phenol novolac which the manufacturer characterizes as a highly butyl etherified resole based on a cresol mixture with a weight average molecular weight from 4000 to 6000 and a polydispersity from 2 to 3. Both of these products are available from UCB Group, a company headquartered in Brussels, Belgium, and its affiliate, UCB GmbH & Co. KG, a company incorporated in Germany. Other resole compounds available from UCB include for example PHENODUR PR 401, PHENODUR PR 411, PHENODUR PR 515, PHENODUR PR 711, PHENODUR PR 612, PHENODUR PR 722, PHENODUR PR 733, PHENODUR PR 565, and PHENODUR VPR 1775.

Other resole compounds available from Bakelite include for example BAKELITE PF 0751 LA, BAKELITE PF 9075 DF, BAKELITE 9900LB, BAKELITE 9435 LA, BAKELITE 0746 LA, BAKELITE 0747 LA, BAKELITE 9858 LG, BAKELITE 9640 LG, BAKELITE 9098LB, BAKELITE 9241 LG, BAKELITE 9989 LB, BAKELITE 0715 LG, BAKELITE 7616 LB, and BAKELITE 7576 LB.

Organophosphorus-Containing Compounds, Component (A)

The organophosphorus-containing compound, Component (A), may be selected from compounds having the group HP═O, P—H, and P—OH. The phosphorus atom may be bonded to two separate organic moieties or may be bonded to one organic moiety. When bonded to one organic moiety, the bonds may connect with the same atom of the organic moiety to form a double bond or, preferably, may be single bonds connecting the phosphorus atom with different atoms in the same organic moiety.

The organophosphorus-containing compound preferably corresponds to the following Formulae (X) to (XXII):

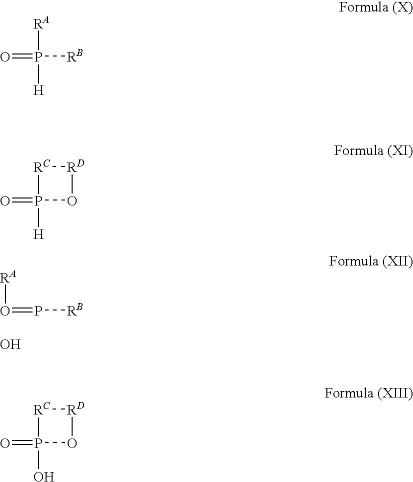

Formula (XIV) R^{A}PH₂
Formula (XV) (R^{A}O)₂P(O)H
Formula (XVI) R^{A}P(O)(OH)H
Formula (XVII) R^{A}P(O)(OH)₂
Formula (XVIII) R^{A}R^{B}P(O)OH
Formula (XIX) (R″O)₂P(O)H
Formula (XX) (R″)₂P(O)H
Formula (XXI) R″P(O)(OH)H
Formula (XXII) R″P(O)(OH)₂

R^{A} and R^{B} may be the same or different and are selected from substituted or unsubstituted aryl or aryloxy groups and hydroxyl groups provided that not more than one of R^{A} and R^{B} is a hydroxyl group, and

R^{C} and R^{D} may be the same or different and are selected from hydrocarbylene and hydrocarbenylene. R^{C} and R^{D} are preferably each independently, more preferably both, an arylene group.

Phenylphosphine is an example of Formula (XIV), diphenyl or diethyl phosphite or dimethylphosphite is an example of Formula (XV), phenylphosphinic acid (C₆H₅)P(O)(OH)H is a an example of Formula (XVI), phenylphosphonic acid (C₆H₅)P(O)(OH)₂ is an example of Formula (XVII), and dimethylphosphinic acid (CH₃)₂P(O)OH is an example of Formula (XVIII).

In a preferred embodiment, the organophosphorus-containing compound, Component (A), corresponds to one of the following chemical Formula (XXIII) to (XXVIII):

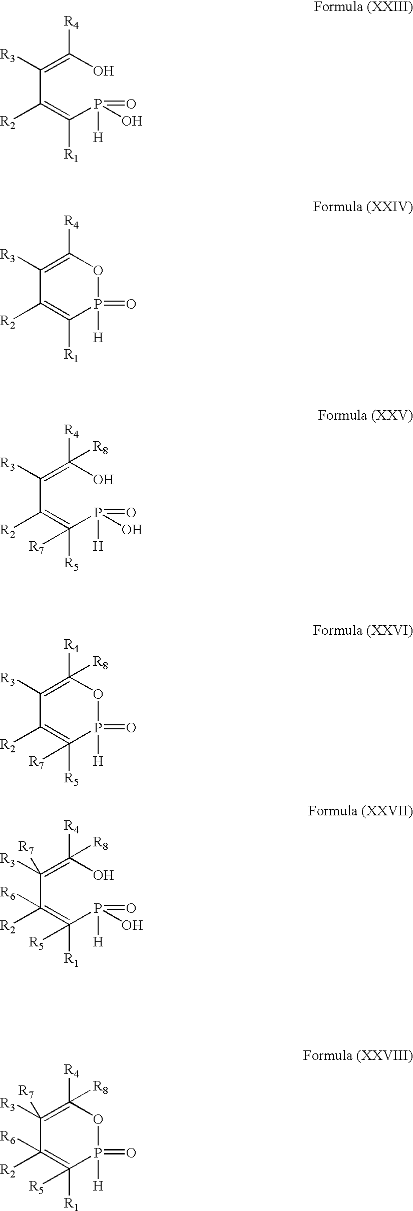

wherein each R₁ to R₈ is, independently, a hydrogen atom or a hydrocarbyl group that optionally may contain one or more heteroatoms such as O, N, S, P, or Si, provided that not more than 3 of R₁ to R₄ are hydrogen atoms and two or more of R₁ to R₈ may be joined to one another to form one or more cyclic groups. The total number of carbon atoms in R₁ to R₈ is preferably in the range from 6 to 100.

In a more preferred embodiment, the organophosphorus-containing compound, Component (A), corresponds to the following Formula (XXIX):

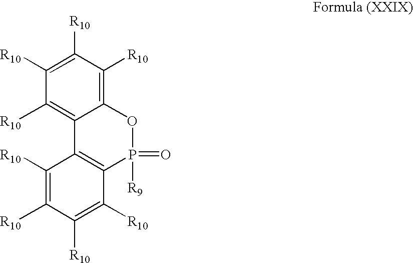

wherein R₉ represents H and each R₁₀ independently represents a hydrogen atom or a hydrocarbyl group that optionally may contain one or more heteroatoms such as O, N, S, P, or Si. Two or more of R₁₀ may be joined to one another to form one or more cyclic groups.

The above preferred embodiment organophosphorus-containing compounds are described in more detail in EP-A-806429.

The organophosphorus-containing compound, Component (A), is preferably 9,10-dihydro-9-oxa-10-phosphaphenanthrene-10-oxide (also known as “DOP”), such as “Sanko-HCA”, which is commercially available from Sanko of Japan, or “StruktolPolydis™ PD 3710”, which is commercially available from Schill & Seilacher of Germany; dimethylphosphite, diphenylphosphite, ethylphosphonic acid, diethylphosphinic acid, methyl ethylphosphinic acid, phenyl phosphonic acid, phenyl phosphinic acid, dimethylphosphinic acid, phenylphosphine, vinyl phosphoric acid; or mixtures thereof.

The organophosphorus-containing compound, Component (A), is preferably substantially free of bromine atoms, more preferably substantially free of halogen atoms.

Reaction of Component (A) with Component (B)

To prepare Compound (I), Component (A) and Component (B) are first blended or mixed together to form a reactive composition. Then a sufficient temperature is applied to the reactive composition of Components (A) and (B) to initiate the reaction between the two components to form Compound (I).

Component (A) is preferably mixed with Component (B) in a reaction vessel at an elevated temperature, i.e., a temperature greater than 25 degrees Celsius, preferably greater than 150 degrees Celsius, more preferably greater than 170 degrees Celsius, preferably below the decomposition temperature of the starting materials and the phosphorus-containing product having the lowest decomposition temperature and for a period of time sufficient to a react the H—P═O, P—H or P—OH moieties of Component (A) with the OR″ moieties of Component (B). The time of reaction is typically from 30 minutes to 20 hours, preferably from 1 hour to 10 hours and more preferably from 2 hours to 6 hours.

The reaction of the present invention is preferably carried out in the absence of water (generally the water is present in less than 5 wt percent, more preferable less than 3 wt percent and most preferable less than 1 wt percent) because water may tend to react with Component (A). Removal of alcohol and other volatile byproducts such as other solvents formed as a byproduct of this reaction generally helps drive the reaction to completion. The pressure in the reaction vessel is therefore preferably reduced to a pressure below atmospheric pressure, such as a pressure of 0.1 bar or less, to help drive off the alcohol or byproducts at a temperature below the above-mentioned lowest decomposition temperature.

The reaction vessel may optionally be purged with a gas or volatile organic liquid to further assist in removing byproduct (s). gas or volatile organic liquid is preferably inert to the contents of the reaction vessel.

Component (B) is usually dissolved in an organic solvent, well know to those skilled in the art, such as butanol, xylene, or Dowanol PM (trademark of The Dow Chemical Company); and part of the solvent can be removed either by heat or applying vacuum to the solution before the addition of Component (A). The order of charging of Component (A) and Component (B) into the reaction mixture is not important.

Components (A) and (B) are preferably combined at a weight ratio in the range from 10:1 to 1:10, preferably from 5:1 to 1:5, more preferably from 2:1 to 1:2, most preferably in the range from 1.1:1 to 1:1.1 based on total solids content of the composition.

If desired, other materials such as catalysts or solvents may be added to the reaction mixture of Component (A) and (B).

The phosphorous-containing product of the present invention, Compound (I), resulting from the reaction between Component (A) and Component (B) has a phosphorus content of preferably at least 4 weight-percent, and more preferably at least 6 weight-percent. The phosphorus content of Compound (I) generally ranges from 4 to 12 percent, preferably from 5 to 9 and more preferably from 6 to 8 weight percent. Component (I) is preferably substantially free of bromine atoms, and more preferably substantially free of halogen atoms.

Compound (I) has a Mettler softening point generally greater than 100° C. and preferably greater than 120° C.; and preferably less than 250° C. and more preferably less than 200° C. The product is preferably a solid at room temperature (about 25° C.) for better storing, shipping and handling.

Generally, the resulting Compound (I) from the reaction of Components (A) and (B) may be a blend of one or more of different oligomers.

Flame Resistant Epoxy Resin Compositions

The phosphorus-containing compound, Compound (I), obtainable by reacting Component (A) with Component (B), as described above, is used to make an epoxy resin by reaction with an epoxy compound (herein referred to as an “epoxidized Compound(I)”).

With epichlorohydrin, a lower molecular weight epoxidized Compound (I) may be obtained such as for example a resin having less than 700. In another embodiment, higher molecular weight epoxy resins such those having molecular weights of greater than 700 may be obtained by reacting (i) the above phosphorus-containing compound, Compound (1) with (ii) at least one epoxy compound having at least one, and preferably two or more, epoxy groups per molecule.

For example, the crosslinkable phosphorus-containing epoxy compound, epoxidized Compound (I), is obtainable by reacting the above-described phosphorus-containing compound, Compound (I), with at least one epoxy compound having more than 1, preferably at least 1.8, more preferably at least 2, epoxy groups per molecule, wherein the epoxy groups are 1,2-epoxy groups. In general, such polyepoxide compounds are a saturated or unsaturated aliphatic, cycloaliphatic, aromatic or heterocyclic compound which possess more than one 1,2-epoxy group. The polyepoxide compound can be substituted with one or more substituents such as lower alkyls. Such polyepoxide compounds are well known in the art. Illustrative polyepoxide compounds useful in the practice of the present invention are described in the Handbook of Epoxy Resins by H. E. Lee and K. Neville published in 1967 by McGraw-Hill, New York and U.S. Pat. No. 4,066,628.

Any of the epoxy resins which can be used in the above compositions to practice of the present invention include polyepoxides having the following general Formula (XXX):

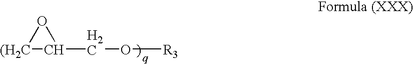

wherein “R3” is substituted or unsubstituted aromatic, aliphatic, cycloaliphatic or heterocyclic group having a valence of “q”, “q” preferably having an average value of from 1 to less than about 8. Examples of the polyepoxide compounds useful in the present invention include the diglycidyl ethers of the following compounds: resorcinol, catechol, hydroquinone, bisphenol, bisphenol A, bisphenol AP (1,1-bis(4-hydroxylphenyl)-1-phenyl ethane), bisphenol F, bisphenol K, tetrabromobisphenol A, phenol-formaldehyde novolac resins, alkyl substituted phenol-formaldehyde resins, phenol-hydroxybenzaldehyde resins, cresol-hydroxybenzaldehyde resins, dicyclopentadiene-phenol resins, dicyclopentadiene-substituted phenol resins tetramethylbiphenol, tetramethyl-tetrabromobiphenol, tetramethyltribromobiphenol, tetrachlorobisphenol A, and any combination thereof.

Examples of particular polyepoxide compounds useful in the present invention include a diglycidyl ether of bisphenol A having an epoxy equivalent weight (EEW) between 177 and 189 sold by The Dow Chemical Company under the trademark D. E.R. 330; the halogen-free epoxy-terminated polyoxazolidone resins disclosed in U.S. Pat. No. 5,112,932, phosphorus element containing compounds disclosed in U.S. Pat. No. 6,645,631; cycloaliphatic epoxies; and copolymers of glycidyl methacrylate ethers and styrene.

Preferred polyepoxide compounds include epoxy novolacs, such as D.E.N. 438 or D.E.N. 439 (trademarks of The Dow Chemical Company); cresole epoxy novolacs such as QUATREX 3310, 3410 and 3710 available from Ciba Geigy; trisepoxy compounds, such as TACTIX 742 (trademark of Ciba Geigy Corporation of Basel, Switzerland); epoxidized bisphenol A novolacs, dicyclopentadiene phenol epoxy novolacs; glycidyl ethers of tetraphenolethane; diglycidyl ethers of bisphenol-A; diglycidyl ethers of bisphenol-F; and diglycidyl ethers of hydroquinone.

In one embodiment, the most preferred epoxy compounds are epoxy novolac resins (sometimes referred to as epoxidized novolac resins, a term which is intended to embrace both epoxy phenol novolac resins and epoxy cresol novolac resins). Such epoxy novolac resin compounds have the general chemical structural formula illustrated by Formula (XXXI) as follows:

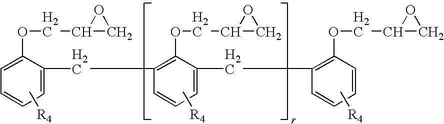

wherein “R4” is hydrogen or a C1-C3 alkyl, for example, methyl; and “r” is 0 or an integer from 1 to 10. “r” preferably has an average value of from 0 to 5. The preferred epoxy novolac resin is when “R4” is preferably a hydrogen atom in the above Formula (XXXI).

Epoxy novolac resins (including epoxy cresol novolac resins) are readily commercially available, for example under the trade names D.E.N. (trademark of The Dow Chemical Company), and QUATREX and TACTIX 742 (trademarks of Ciba Geigy). The materials of commerce generally comprise mixtures of various species of the above Formula (XXXI) and a convenient way of characterizing such mixtures is by reference to the average, r′, of the values of r for the various species. Preferred epoxy novolac resins for use in accordance with the present invention are those in which r′ has a value of from 0 to 10, more preferably from 1 to 5.

Additional examples of epoxy-containing compounds useful in the present invention are the reaction products of an epoxy compound containing at least two epoxy groups and a chain extender as described in WO 99/00451. The preferred reaction product described in WO 99/00451 useful in the present invention is an epoxy-polyisocyanate adduct or an epoxy-terminated polyoxazolidone as described in U.S. Pat. No. 5,112,932. The isocyanate compounds as chain extenders include for example diphenylmethane diisocyanate (MDI), toluene diisocyanate (TDI) and isomers thereof.

The polyepoxide useful in the present invention is preferably substantially free of bromine atoms, and more preferably substantially free of halogen atoms.

An example of polyepoxides that are useful in the present invention and that are substantially free of halogen atoms are the phosphorus-containing epoxy resins described in U.S. Pat. No. 6,645,631. The polyepoxides disclosed in U.S. Pat. No. 6,645,631 are the reaction products of an epoxy compound containing at least two epoxy groups and a reactive phosphorus-containing compound such as 3,4,5,6-dibenzo-1,2-oxaphosphane-2-oxide (DOP), or 10-(2′,5′-dihydroxyphenyl)-9,10-dihydro-9-oxa-10-phosphaphenanthrene-10-oxide (DOP-HQ).

Hardener

The aromatic hardening agent can be any aromatic hardener which has an amine group and a sulphone group, and is preferably present in an amount of from 10 to 30, weight percent more preferably from 15 to 20 weight percent, based on the total weight of the curable composition. The hardener is preferably latent and thermally stable.

Particularly suitable hardeners include one or more of 4,4′diaminodiphenylsulphone; 3,3′diaminodiphenylsulphone; 2-(phenylsulfonyl)aniline; sulphanilamide, or derivatives thereof. 4,4′diaminodiphenylsulphone is particularly preferred.

Other suitable hardeners which can be used in combination with the above aromatic hardeners include, for example derivatives of methyldiphenylaniline (MDA) or hardeners that catalytically cure the epoxy system such as imidazoles or other lewis acids, particularly boron-containing hardeners such as BF₃MEA (monoethanolamine) and BF₃ etherate.

Optional Components

The composition can also comprise various additional optional components, including catalysts, dyes, fillers, rheology modifiers and toughening reagents.

The features of the various embodiments of the present invention can be combined with one another.

Preferred embodiments of the present invention will now be described with reference to the following Examples.

### Examples

### Example 1

A curable epoxy resin composition was made by mixing:

100±5 parts by weight of DEN438, a semi-solid epoxy novolac resin which is the reaction product of epichlorohydrin and phenol-formaldehyde novolac and is commercially available from the Dow Chemical Company;

33±3 parts of a phosphorous-containing phenolic epoxy resin, which is a methyl-dioxaphosphorphenantrene-oxide modified bisphenol-A-novolac;

32 parts diaminodiphenylsulphone;

4±0.5 part 2-phenylimidazol accelerator;

25±5 parts Dowanol™ PM, a propylene glycol methyl ether;

1±0.5 parts Boric Acid; and

20±5 parts methyl-ethyl-ketone.

The exact ratios of the components is given in the following table:

| | Example 1 | | | |
|---|---|---|---|---|
| Material | Solids | Solution | Reactivity | Viscosity |
| D.E.N. 438 ™ | 99.2205 | 99.22 | | |
| Phenolic Epoxy Resin | 32.958 | 54.93 | | |
| 4,4-DDS | 30 | 30 | | |
| 2-PHI (20% Solution in | 3.98 | 10.67 | >5 min | |
| Dowanol ™ PM) | | | | |
| Boric acid (20% in | 1 | 5 | | |
| methanol) | | | | |
| Dowanol ™ PM | | 10 | | |
| MEK | 0 | 20 | | |
| | 166.1665 | 241.6 | | ~3000 mPas |
| Appearance | | Turbid | | |
| | | Solution | | |

The varnish formulation was used to impregnate glass weave (7628 style from Porcher/finish 0731) and the impregnated glass weave was run through a horizontal treater oven (Caratsch/3 m oven length) at a speed of 1.3 m/min and at 175° C. oven temperature. This operation removes the solvent to produce a prepreg which can be used to make a laminate by stacking 8 sheets of the prepreg between copper foil (35 μm thickness) and subjecting this stack in a press to a press temperature of 210° C. for 90 minutes at 15 kN/m² pressure.

The resulting laminates have the following characteristics:

| Laminate Requirement | Condition | Example 1 | Comparative 1 | Comparative 2 | Requirement | Units | Test Method |
|---|---|---|---|---|---|---|---|
| ANSI Type | | | Fr-4 | G10 | | | |
| Maximum Operating Temp | | 200 | 130 | 140 | | | |
| Peel strength | | 1.7 (9.7) | 1.05 (6) | | | N/mm (lb/inch) | 2.4.8 |
| Peel strength | After Thermal Stress | 1.7 (9.7) | | | | N/mm (lb/inch) | 2.4.8 |
| | 288° C. | | | | | | |
| Peel strength | After Thermal Stress | 0.595 (3.4) | | | >1 lb/inch | N/mm (lb/inch) | 2.4.8 |
| | 288 deg C. and after 10 | | | | | | |
| | Days @ 252° C. | | | | | | |
| Flammability, (Laminate | | v-1 [17] | v-0 | Not Flame | | Rating [sec] | UL94 |
| & Prepreg as laminated) | | | | Retardant | | | |
| Glass Transition | TMA | 183 | 170 | 160 | | ° C. | 2.4.24 |
| Temperature | | | | | | | |
| Glass Transition | DSC | 201 | 175 | 160 | | ° C. | 2.4.25 |
| Temperature | | | | | | | |
| T260 | TMA (Copper removed) | >60 | 10 | | | Minutes | 2.4.24.1 |
| T288 | TMA (Copper removed) | >60 | 0 | | | Minutes | 2.4.24.1 |
| T300 | TMA (Copper removed) | >60 | 0 | | | Minutes | 2.4.24.1 |
| Td | TMA (Copper removed) | | | | | | 2.4.24.1 |
| | 1% wt. loss | 285.05 | | 333.46 | | [° C.] | |
| | 2% wt loss | 347.87 | | 358.30 | | [° C.] | |
| | 3% wt loss | 373.99 | | 379.86 | | [° C.] | |
| | 5% wt loss | 387.15 | 315 | 394.59 | | [° C.] | |

The test methods used to produce the results in the above table are the IPC standard testing methods which are available from IPC (www.ipc.org).

Comparative Example 1 is FR406 and Comparative Example 2 is PCT-GE-120(d) which are commercially available from Isola USA Corporation. The comparative data for these samples is taken from results published in the Underwriters Laboratories directory.

As can be seen, Example 1 has a peel strength of greater than 1 lb/inch after ageing for 10 days at 252° C. This means that this composition can be classified as an MOT200 material.

The material is also flame retardant. Example 1 also has a glass transition temperature of greater than 200° C. when measured by DSC.

By contrast, Comparative Example 1 has a MOT value of 135 and Comparative Example 2 has a MOT value of 150. In addition, G11 is not a flame retardant material.

The compositions according to the present invention can be seen to have improved maximum operating temperatures whilst at the same time providing flame retardancy.

1. A curable halogen-free epoxy resin composition comprising:
from 40 to 80 percent by weight of a phenol aldehyde condensation product;
from 10 to 40 percent by weight of a phosphorous-containing phenolic epoxy resin; and
from 10 to 40 percent by weight of an aromatic hardening agent having a sulphone group and an amine group.

2. A curable halogen-free epoxy resin composition as claimed in claim 1, wherein the phenol aldehyde condensation product is a novolac epoxy resin.

3. A curable halogen-free epoxy resin composition as claimed in claim 1 or claim 2, wherein the phosphorous-containing phenolic epoxy resin is formed from the reaction of a phenolic epoxy resin with a phosphorous containing compound wherein the phosphorous containing compound is the reaction product of:
at least one organophosphorus compound having a group selected from the group H—P═(O); the group P—H and the group P—OH and
at least one compound having Formula (I):
[R′(Y)_{m′}]ₘ(X—O—R″)ₙ Formula (I)
wherein
R′ is an alkyl or aryl group having from 1 to 24 carbon atoms;
Y is selected from hydroxy, carboxylic acid, carboxylate, acid anhydride, amine, —SH, —SO₃H, —CONH₂, —NHCOOR′, phosphate and phosphinate groups;
X is a hydrocarbylene group;
R″ is hydrogen or a hydrocarbyl group having from 1 to 8 carbon atoms; R is alkyl or aryl group having from 1 to 12 carbon atoms; and m′, m and n are, independently, equal to or greater than 1.

4. A composition as claimed in any one of claims 1 to 3, wherein the composition additionally comprises a curing agent.

5. A composition as claimed in any one of the preceding claims comprising:
from 30 to 70 parts by weight of the novolac epoxy resin;
from 15 to 30 parts by weight of the phosphorous-containing phenolic epoxy resin and;
from 15 to 30 parts by weight of the aromatic hardening agent.

6. A composition as claimed in any one of the preceding claims, wherein the novolac epoxy resin is present in an amount of from 50 to 70 weight percent.

7. A composition as claimed in any one of the preceding claims, wherein the phosphorous-containing phenolic epoxy resin is present in an amount of from 15 to 20 weight percent.

8. A composition as claimed in any one of the preceding claims, wherein the aromatic hardening agent is present in an amount of from 15 to 20 weight percent.

9. A composition having a glass transition temperature of greater than 200° C., wherein the composition comprises the cured composition of any one of claims 1 to 8.

10. A method of making a prepreg comprising the step of impregnating a reinforcing web with the composition of any one of claims 1 to 8.

11. A method of making an electrical laminate comprising the steps of: heating the prepreg of claim 10 to a temperature sufficient to partially react the epoxy component of the composition;
laminating one or more layers of the prepreg with an electrically conductive material; and heating the so formed laminate at elevated pressure and elevated temperature to form an electrical laminate.

12. A curable epoxy resin composition comprising:
from 40 to 80 percent by weight of a phenol aldehyde condensation product;
from 10 to 40 percent by weight of a phosphorous-containing phenolic epoxy resin; and
from 10 to 40 percent by weight of an aromatic hardening agent having a sulphone group and an amine group, wherein the composition is substantially free of halogen.
